(19) United States
(12) Patent Application Publication
(10) Pub. No.: US 2019/0113730 A1
(43) Pub. Date: Apr. 18, 2019

(54) OBSERVATION APPARATUS

(71) Applicant: OLYMPUS CORPORATION, Tokyo (JP)

(72) Inventor: Kentaro YAMAZAKI, Tokyo (JP)

(73) Assignee: OLYMPUS CORPORATION, Tokyo (JP)

(21) Appl. No.: 16/156,395

(22) Filed: Oct. 10, 2018

(30) Foreign Application Priority Data
Oct. 16, 2017 (JP) 2017-200063

(51) Int. Cl. G02B 21/02

(52) U.S. Cl. CPC G02B 21/02

(57) ABSTRACT

An observation apparatus includes an objective that receives light from a sample and an imaging optical system that forms an image of the sample. The objective and the imaging optical system are positioned in a manner such that a front focal position of the imaging optical system does not coincide with a rear focal position of the objective. The imaging optical system has a focal length shorter than a focal length of a second imaging optical system. An optical system that includes the objective and the second imaging optical system has a projection magnification equal to a magnification defined by the objective.

### CROSS REFERENCE TO RELATED APPLICATIONS

This application is based upon and claims the benefit of priority from prior Japanese Patent Application No. 2017-200063, filed Oct. 16, 2017, the entire contents of which are incorporated herein by this reference.

### BACKGROUND OF THE INVENTION

### Field of the Invention

The present invention relates to an observation apparatus that accommodates observations at a plurality of magnifications without switching between objectives.

### Description of the Related Art

In an observation with an immersion objective, it is typically difficult to switch between a plurality of objectives due to use of an immersion liquid. An exemplary cause of this is that in switching between a low-magnification objective that does not use an immersion liquid and a high-magnification objective that uses an immersion liquid, it is difficult to add the immersion liquid and bubbles are easily formed in the liquid.

In an observation with immersion objectives, accordingly, it is difficult in practice to change a magnification by switching between objectives.

Japanese Laid-open Patent Publication No. 8-190056 describes an observation optical apparatus that changes a magnification without switching between objectives.

### SUMMARY OF THE INVENTION

An observation apparatus in accordance with an aspect of the present invention includes an objective that receives light from a sample and an imaging optical system that forms an image of the sample by focusing the light from the objective. The objective and the imaging optical system are positioned in a manner such that a front focal position of the imaging optical system does not coincide with a rear focal position of the objective. The imaging optical system has a focal length shorter than that of a second imaging optical system. An optical system that includes the objective and the second imaging optical system has a projection magnification equal to a magnification defined by the objective.

### BRIEF DESCRIPTION OF THE DRAWINGS

The present invention will be more apparent from the following detailed description when the accompanying drawings are referenced.

FIG. 1 illustrates an exemplary arrangement of an objective 1 and an imaging optical system 2 of an observation apparatus;

FIG. 2 illustrates another exemplary arrangement of an objective 1 and an imaging optical system 2 of an observation apparatus;

FIG. 3 illustrates a portion of the configuration of an observation apparatus in accordance with a first embodiment;

FIG. 4 illustrates a portion of the configuration of an observation apparatus in accordance with a second embodiment;

FIG. 5 illustrates a portion of the configuration of an observation apparatus in accordance with a third embodiment;

FIG. 6 illustrates a variation of an observation apparatus in accordance with a third embodiment; and

FIG. 7 illustrates a portion of the configuration of an observation apparatus in accordance with a fourth embodiment.

### DESCRIPTION OF THE EMBODIMENTS

Components for changing a magnification without switching between objectives require techniques for allowing observations to be performed at different magnifications by using one objective, including a component for ensuring a NA required to accommodate an observation at a high magnification while using a low-magnification objective, and a component for ensuring a wide field of view to accommodate an observation at a low magnification while using a high-magnification objective. In the following, accordingly, descriptions will be given of a technique for ensuing a field of view wider than that defined by the magnification of a high-magnification objective so that the objective can accommodate an observation at a low magnification.

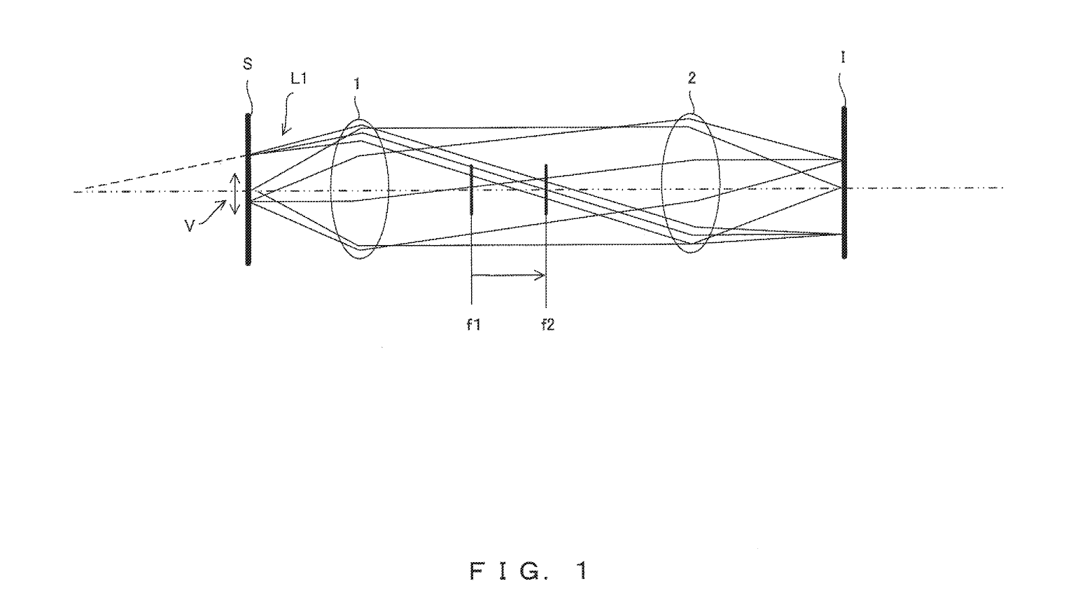

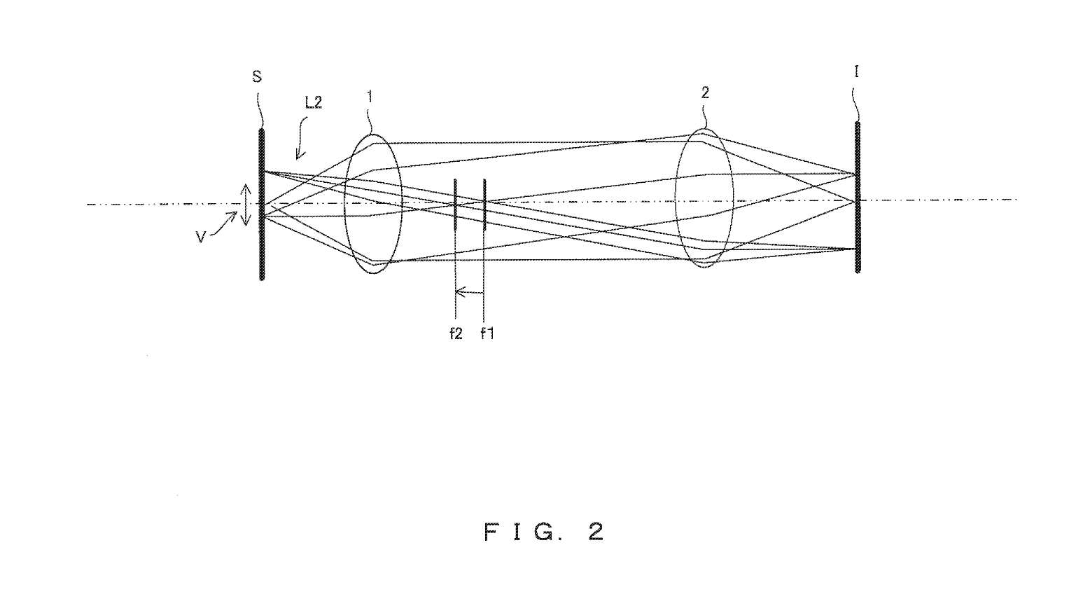

The following describes an observation apparatus of the present invention. First, by referring to FIGS. 1 and 2, descriptions will be given of operations of an objective and a tube lens of an observation apparatus, wherein the operations are features shared between observation apparatuses in accordance with embodiments of the invention.

FIG. 1 illustrates an exemplary arrangement of an objective 1 and an imaging optical system 2 of an observation apparatus of the invention. The objective 1 receives light from a sample S and guides the light to the imaging optical system 2 provided on a subsequent stage. The imaging optical system 2 forms an image of the sample S on an image plane I by focusing the light from the objective 1. The image plane I includes a rear focal position of the imaging optical system 2. The objective 1 may include a plurality of lenses. The imaging optical system 2 may include a plurality of lenses or may be a single lens. An imaging optical system may be referred to as a tube lens.

The imaging optical system 2 has as one salient feature a focal length such that the observation apparatus has a projection magnification lower than a magnification defined by the objective 1. In other words, when an optical system that includes the objective 1 and the second imaging optical system has a projection magnification equal to a magnification defined by the objective 1, the imaging optical system 2 has a focal length shorter than the focal length of the second imaging optical system. The focal length of the second imaging optical system may be hereinafter referred to as a defined focal length. A magnification defined by an objective, i.e., a magnification specified according to a specification for the objective, refers to the total magnification of a combination of the objective and a tube lens that has a predetermined focal length ((focal length of tube lens)/(focal length of objective)). When, for example, an ordinarily used tube lens has a focal length of 200 mm, an objective having a focal length of 20 mm is defined as a lens with a 10-fold magnification, and an objective having a focal length of 2 mm is defined as a lens with a 100-fold magnification.

Making the focal length of the imaging optical system 2 shorter than the defined focal length allows an optical image to be formed by focusing, on an image plane, light from a wider range on a sample than a range on the sample from which light would be sent in the case of using a tube lens having the defined focal length. This also allows the magnification of the optical image generated by the imaging optical system 2 to be decreased. Accordingly, in, for example, a configuration in which an optical image is formed by the imaging optical system 2 focusing light on an image sensor included in a camera, the objective 1 can receive light from a wider field of view on a sample S and form an optical image by focusing the light on the image sensor provided on the subsequent stage (that is, a position of the subsequent stage is closer to the image plane than a position where the objective is placed is) without vignetting.

In the meantime, typical objectives and tube lenses use, as observation light, light that includes telecentric principal rays (light that includes principal rays that become parallel to an optical axis on the object side of an optical system, which may hereinafter be referred to as telecentric light). In such a configuration in accordance with a typical objective and tube lens, the field of view can be widened by shortening the focal length of an imaging optical system, only to the extent that the objective can receive telecentric light. This is because even if the focal length is shortened beyond the extent that the objective 1 can receive telecentric light, no information can be obtained for portions for which light from the sample is not guided. Accordingly, the feature of providing a focal length that is shorter than the defined focal length merely allows a field of view to be widened to only a limited extent by using one objective.

Another salient feature of the objective 1 and the imaging optical system 2 described in the following allows a wider field of view to be provided using the one objective 1. Descriptions will be given of that feature in the following.

The objective 1 and the imaging optical system 2 are positioned in a manner such that a front focal position of the imaging optical system 2, focal position f2, does not coincide with a rear focal position of the objective 1, focal position f1. More particularly, for example, in order to focus, on an image plane, light with non-telecentricity from a sample S that includes principal rays forming a certain angle with the optical axis (this light may hereinafter be referred to as non-telecentric light), the objective 1 and the imaging optical system 2 may be positioned in a manner such that the focal position f2 of the imaging optical system 2 is more distant from the sample S than the focal position f1 of the objective 1 is. The non-telecentric light is non-telecentric light L1 generated from an outside of a range on the sample S from which the telecentric light that can be received by the objective 1 (an outside of range V in FIG. 1) is emitted. The outside refers to a region more distant from the optical axis. The focal position f2 is desirably a position at which the non-telecentric light L1 crosses the optical axis of the objective 1, or a position close to that position. In such a configuration, the non-telecentric light L1 received by the objective 1 forms an image at or near the rear focal position of the imaging optical system 2, thereby forming an image on an image plane I on a stage subsequent to the imaging optical system 2. The line at the center of the non-telecentric light L1 depicted in FIG. 1 represents principal rays.

Non-telecentric light typically includes a bundle of rays that is thinner than that of telecentric light. The objective 1 can receive non-telecentric light from a wider range on a sample S. However, in a conventional configuration related to an objective and a tube lens in which observations are performed by primarily using telecentric light with a front focal position of an imaging optical system located at or near a rear focal position of the objective, non-telecentric light L1 from a position on the sample S more distant from an optical axis than the range V described above is, is not used for the observation and does not contribute to the forming of an image on the image plane I. Meanwhile, positioning the objective and the imaging optical system as depicted in FIG. 1 allows non-telecentric light L1 to be focused on the image plane, i.e., allows non-telecentric light L1 to contribute to the forming of an optical image. This enables observation of a wider range than the range V on the sample S from which the objective 1 can receive telecentric light. In particular, the sample S can be observed using one objective with a wider field of view than a field of view achieved in an observation in which telecentric light is primarily used.

The objective 1 and the imaging optical system 2 may be positioned in a manner such that the focal position f2 of the imaging optical system 2 and the focal position f1 of the objective 1 do not coincide with each other, thereby allowing non-telecentric light forming a certain angle with the optical axis to be focused to form an image while achieving a wide field of view for the observation. The positions of the objective 1 and the imaging optical system 2 of the invention are not limited to those depicted in FIG. 1. For example, the objective 1 and the imaging optical system 2 may be positioned in a manner such that as depicted in FIG. 2, the focal position f2 of the imaging optical system 2 is closer to the sample S than the focal position f1 of the objective 1 is, thereby allowing an image to be formed by the imaging optical system 2 by guiding, to the imaging optical system 2, non-telecentric light L2 angled differently from the non-telecentric light depicted in FIG. 1.

As described above, the positioning of the objective 1 and the imaging optical system. 2 of the observation apparatus of the invention allows, while using one objective 1, a field of view that is wider than a field of view defined by a magnification of the objective 1 to be ensured.

The following describes observation apparatuses of embodiments of the invention, the observation apparatuses including the configuration described above.

### First Embodiment

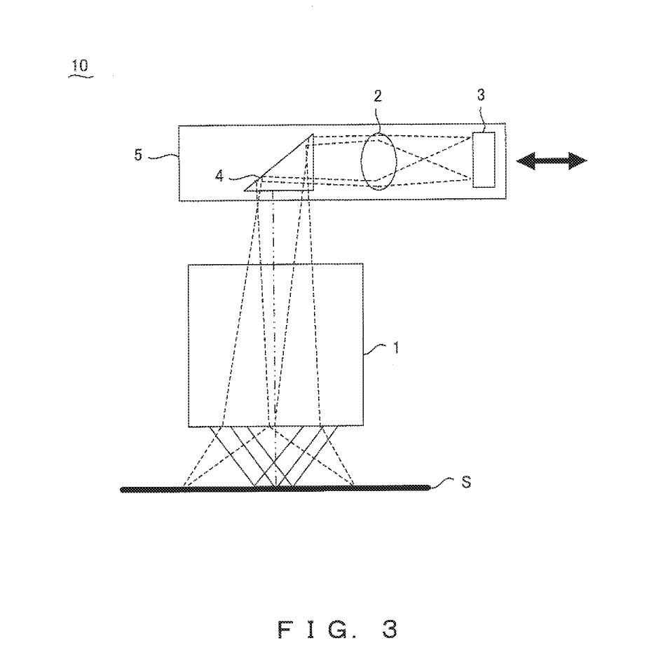

FIG. 3 illustrates a portion of the configuration of an observation apparatus 10 in accordance with a first embodiment. The observation apparatus 10 is a microscope apparatus and includes an objective 1 and a slider 5 disposed on a stage subsequent to the objective 1 and insertable/removable onto/from an optical path of the objective 1.

The slider 5 includes a prism 4, an imaging optical system 2, and an image capturing apparatus 3. The prism 4 serves as a total reflection mirror and guides light from the objective 1 to the imaging optical system 2 when the slider 5 has been inserted. When the slider 5 has been inserted, the imaging optical system 2 and the objective 1 have the relationship in position described above by referring to FIGS. 1 and 2. Accordingly, the imaging optical system 2 and the objective 1 form an image by focusing non-telecentric light from a sample S on an image plane. For example, the slider 5 may be inserted or removed at a position within a revolver on which the objective 1 is mounted, the position is at which a DIC slider is to be inserted.

The observation apparatus 10 also includes an imaging optical system (second imaging optical system) (not illustrated) and an image capturing apparatus (not illustrated). When the slider 5 has been removed from the optical path, the imaging optical system forms on the image capturing apparatus an image by focusing light from the objective 1. Accordingly, the prism 4 included in the slider 5 serves as an optical path switching element for choosing an optical path incident on the imaging optical system 2 as an optical path on which light from the objective is to travel.

The second imaging optical system has a front focal position located at or near a focal position f1 of the objective 1 and has a focal length such that a combination of the objective 1 and the second imaging optical system has a projection magnification equal to a magnification defined by the objective 1. Accordingly, the objective 1 and the second imaging optical system are a conventional objective and imaging optical system for observations primarily using telecentric light.

An optical path switching element is located on an optical path between the imaging optical system 2 and a sample. Accordingly, an imaging optical system is not disposed on an optical path on a stage preceding the optical path switching element (optical path on sample-S side). When the prism 4 is a half mirror or a dichroic mirror, the prism 4 serves as an optical path dividing element that divides an optical path into a transmitted light path and a reflected light path. The optical path dividing element divides an optical path of light from the objective 1 into an optical path incident on the imaging optical system and an optical path incident on the second imaging optical system. As with the optical path switching element, the optical path dividing element is disposed between the imaging optical system 2 and the sample.

According to the configuration of the observation apparatus 10 described above, when the slider 5 has been removed, an observation is performed with a field of view defined by the magnification of the objective 1, and when the slider 5 has been inserted, an observation can be performed with a field of view wider than that defined by the magnification of the objective 1. Accordingly, by inserting or removing the slider 5 that includes the prism 4, both an observation with the original magnification of the objective 1 and an observation with a magnification lower than the original magnification of the objective 1 can be performed using the single objective 1, i.e., without replacing the objective.

The described configuration, in which an objective does not need to be replaced, is effective particularly when an immersion objective, i.e., an objective that is in practice difficult to replace during an observation, is used. Problems, e.g., generation of bubbles between an objective and an immersion liquid that could occur in switching between a plurality of objectives, would not occur, and an immersion liquid would not need to be added to compensate for a loss of the liquid that could be caused in the switching of the objective.

Note that the objective 1, imaging optical system 2, and second imaging optical system indicated with reference to the embodiments described hereinafter have the same relationships in position as those described above and perform the same operations as those described above.

### Second Embodiment

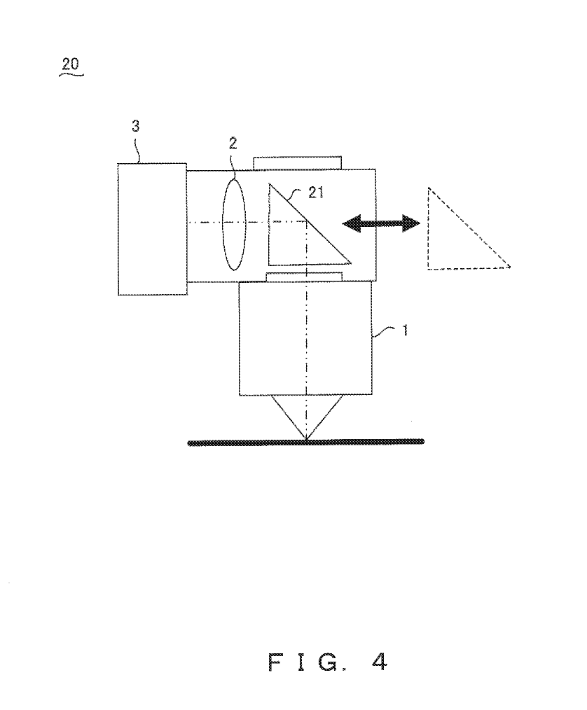

FIG. 4 illustrates a portion of the configuration of an observation apparatus 20 in accordance with a second embodiment. This configuration includes an imaging optical system 2 and an image capturing apparatus 3 and is different from the observation apparatus 10 in accordance with the first embodiment in that instead of the slider 5, the configuration includes a prism 21 insertable/removable onto/from an optical path. The prism 21 has a mirror.

For example, the prism 21 may be installed in an insertable/removable manner within a single nosepiece on which an objective 1 is mounted. When the prism 21 has been inserted onto an optical path, light from the objective 1 is guided to the imaging optical system 2, and when the prism 21 has been removed from the optical path, light from the objective 1 is guided to a second imaging optical system (not illustrated). Accordingly, the prism 21 functions as an optical path switching element for switching between an optical path incident on the imaging optical system 2 and an optical path incident on the second imaging optical system for an optical path of light from the objective. Meanwhile, the imaging optical system 2 and the image capturing apparatus 3 are fixed.

As described above, the prism 21 may be inserted or removed as an optical path switching element. Instead of the prism 21, a dichroic mirror may be used to divide an optical path into an optical path leading to the imaging optical system 2 and an optical path leading to the second imaging optical system. When a dichroic mirror or a half mirror is used, an optical path can be divided without inserting or removing an optical element or a slider, and hence a component for inserting or removing the optical element or the slider may be unnecessary.

### Third Embodiment

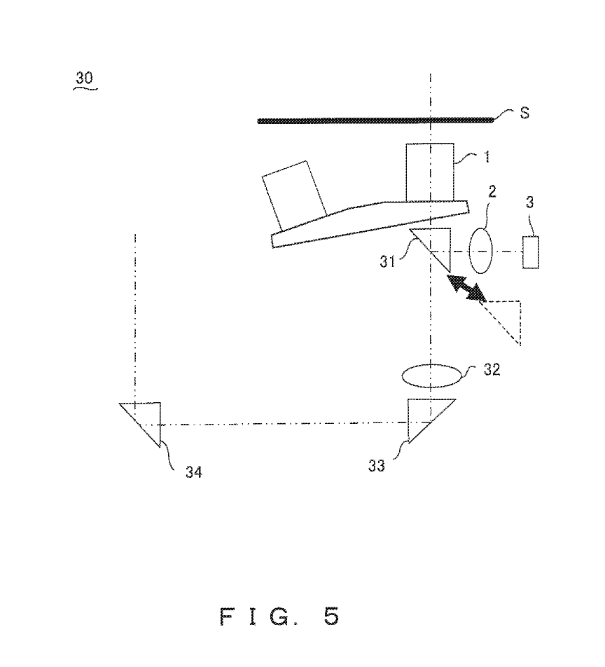

FIG. 5 illustrates a portion of the configuration of an observation apparatus 30 in accordance with a third embodiment. The observation apparatus 30 is an inverted microscope and includes an objective 1 mounted on a revolver, an insertable/removable prism 31, an imaging optical system 2, an image capturing apparatus 3, a tube lens 32, and prisms 33 and 34.

The prism 31, which includes a mirror, is installed in an insertable/removable manner within a microscope body provided on a stage subsequent to the revolver. When the prism 31 has been inserted into an optical path, light from the objective 1 is guided to the imaging optical system 2, and when the prism 31 has been removed from the optical path, light from the objective 1 is guided to the tube lens 32. The tube lens 32, i.e., a second imaging optical system, guides incident light to an image capturing apparatus (not illustrated) provided on a subsequent stage via the prisms 33 and 34, which have total reflection surfaces. This allows an observation to be performed using typical telecentric light. Accordingly, the prism 31 functions as an optical path switching element for switching between an optical path incident on the imaging optical system 2 and an optical path incident on the second imaging optical system (tube lens 32) for an optical path of light from the objective.

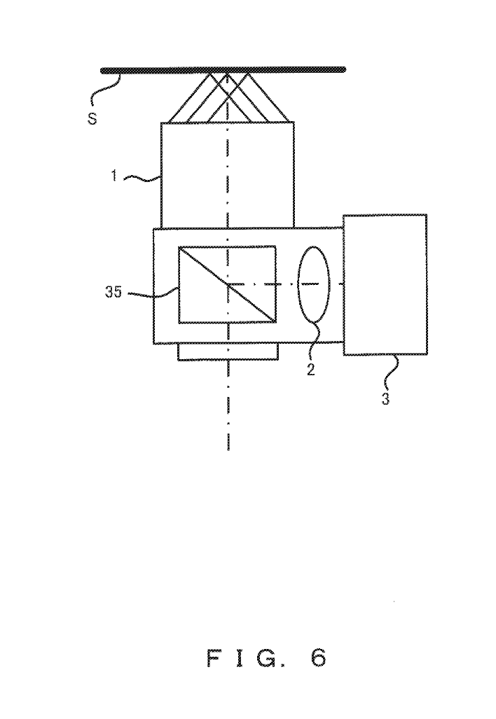

As described above, the optical path switching element does not necessarily need to be included within a revolver (nosepiece) but may be installed within the microscope body. As depicted in FIG. 6, instead of the prism 31, i.e., an optical path switching element, an optical path dividing element 35 may be installed within the microscope body. The optical path dividing element 35 is, for example, a dichroic mirror or a half mirror.

### Fourth Embodiment

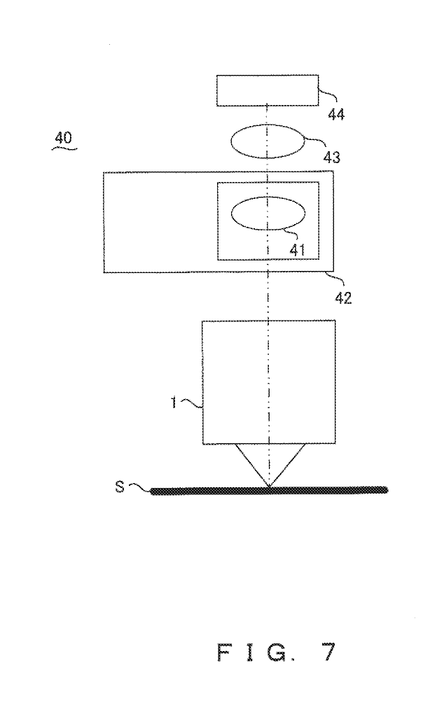

FIG. 7 illustrates a portion of the configuration of an observation apparatus 40 in accordance with a fourth embodiment. The observation apparatus 40 includes an objective 1, a turret 42, a second imaging optical system 43, and an image capturing apparatus 44, wherein the second imaging optical system 43 and the image capturing apparatus 44 are disposed on an optical path on a stage subsequent to the turret 42.

The turret 42 holds an optical system. 41 on an optical path in an insertable/removable manner. More particularly, when the turret 42 has inserted the optical system 41 onto the optical path, the turret 42 is installed in a manner such that a combinational optical system comprising the optical system 41 and the second imaging optical system 43 has a front focal position that does not coincide with a rear focal position of the objective 1. Accordingly, the optical system that is a combination of the optical system 41 and the second imaging optical system 43 corresponds to the imaging optical system 2 described above and has functions similar to those of the imaging optical system 2. Therefore, using the objective 1 and the optical system that corresponds to the imaging optical system 2 (an optical system that is a combination of the optical system 41 and the second imaging optical system 43), non-telecentric light can be guided to the image capturing apparatus 44 so that an observation can be performed with a field of view wider than that defined by the objective 1.

When the turret 42 has removed the optical system 41 from the optical path, light from the objective 1 is guided to the image capturing apparatus 44 via the second imaging optical system 43. Accordingly, using telecentric light, an observation is performed with a field of view defined by the objective 1.

In addition, an optical system that is a combination of the optical system 41 and the second imaging optical system 43 has a focal length shorter than that of the second imaging optical system 43. Accordingly, the optical system that is a combination of the optical system 41 and the second imaging optical system 43 has a focal length such that the optical system has a projection magnification lower than a magnification defined by the objective 1.

According to the configuration of the observation apparatus 40 described above, as described above with reference to the first to third embodiments, by inserting/removing the optical system 41 into/from the optical path, both an observation with the original magnification of the objective 1 and an observation with a magnification lower than the original magnification of the objective 1 can be performed using the single objective 1 without providing a plurality of imaging optical systems.

The embodiments described above are indicated as specific examples to facilitate the understanding of the present invention, and the invention is not limited to those embodiments. Various modifications or changes can be made to the observation apparatus described above without departing from the invention recited in the claims.

What is claimed is:

1. An observation apparatus comprising:
an objective configured to receive light from a sample; and
an imaging optical system configured to form an image of the sample by focusing the light from the objective, wherein
the objective and the imaging optical system are positioned in a manner such that a front focal position of the imaging optical system does not coincide with a rear focal position of the objective,
the imaging optical system has a focal length shorter than a focal length of a second imaging optical system, and
an optical system that includes the objective and the second imaging optical system has a projection magnification equal to a magnification defined by the objective.

2. The observation apparatus of claim 1, wherein
the objective and the imaging optical system are positioned in a manner such that the front focal position of the imaging optical system is more distant from the sample than the rear focal position of the objective is.

3. The observation apparatus of claim 1, further comprising:
the second imaging optical system, the second imaging optical system being configured to form an image of the sample by focusing light from the objective.

4. The observation apparatus of claim 2, further comprising:
the second imaging optical system, the second image optical system being configured to form an image of the sample by focusing light from the objective.

5. The observation apparatus of claim 3, further comprising:
an optical path switching element configured to switch an optical path of light from the objective into an optical path incident on the imaging optical system.

6. The observation apparatus of claim 4, further comprising: an optical path switching element configured to switch an optical path of light from the objective into an optical path incident on the imaging optical system.

7. The observation apparatus of claim 5, wherein
the optical path switching element is located on an optical path between the imaging optical system and the sample.

8. The observation apparatus of claim 6, wherein
the optical path switching element is located on an optical path between the imaging optical system and the sample.

9. The observation apparatus of claim 3, further comprising:
an optical path dividing element configured to divide an optical path of light from the objective into an optical path incident on the imaging optical system and an optical path incident on the second imaging optical system.

10. The observation apparatus of claim 4, further comprising:
an optical path dividing element configured to divide an optical path of light from the objective into an optical path incident on the imaging optical system and an optical path incident on the second imaging optical system.

11. The observation apparatus of claim 9, wherein
the optical path dividing element is an insertable/removable optical element.

12. The observation apparatus of claim 10, wherein
the optical path dividing element is an insertable/removable optical element.

13. The observation apparatus of claim 11, wherein
the optical path dividing element is located on an optical path between the imaging optical system and the sample.

14. The observation apparatus of claim 12, wherein
the optical path dividing element is located on an optical path located between the imaging optical system and the sample.

15. The observation apparatus of claim 5, wherein
the optical path switching element is a prism.

16. The observation apparatus of claim 9, wherein
the optical path dividing element is a dichroic mirror.

17. The observation apparatus of claim 9, wherein
the optical path dividing element is a half mirror.

18. The observation apparatus of claim 9, wherein
the optical path dividing element is a prism.

19. The observation apparatus of claim 3, wherein
the imaging optical system includes the second imaging optical system and an optical system insertable/removable onto/from an optical path between the objective and the second imaging optical system,
when the optical system has been inserted onto the optical path, the objective and the imaging optical system are positioned in a manner such that the front focal position of the imaging optical system does not coincide with the rear focal position of the objective, and
when the optical system has been inserted onto the optical path, the imaging optical system has a focal length shorter than the focal length of the second imaging optical system.

20. The observation apparatus of claim 1, wherein
the observation apparatus is a microscope apparatus.
